(19) United States
(12) Patent Application Publication
(10) Pub. No.: US 2025/0273972 A1
(43) Pub. Date: Aug. 28, 2025

(54) Battery Management System For A Marine Battery

(71) Applicant: Systematic Power Solutions, LLC, Knoxville, TN (US)

(72) Inventors: Kevin J. Bennett, Corryton, TN (US); Alan J. Testani, Boca Raton, FL (US)

(73) Assignee: Systematic Power Solutions, LLC, Knoxville, TN (US)

(21) Appl. No.: 19/094,935

(22) Filed: Mar. 30, 2025

Related U.S. Application Data
(63) Continuation-in-part of application No. 19/048,189, filed on Jan. 1, 0001.
(60) Provisional application No. 63/756,199, filed on Feb. 9, 2025.
(60) Provisional application No. 63/411,261, filed on Sep. 29, 2022.

(30) Foreign Application Priority Data
Sep. 29, 2023 (WO) PCT/US2023/075533

(51) Int. Cl. H02J 7/00; H01M 10/44; H01M 10/48

(52) U.S. Cl. CPC H02J 7/0014; H01M 10/441; H01M 10/482; H02J 7/00032; H02J 7/0042; H01M 2220/20

(57) ABSTRACT

A battery for marine applications. The battery includes a plurality of battery cells, wherein the battery cells are designed to accommodate draining charge down to zero volts. The battery includes a battery management system (BMS). The BMS comprises one or more connectors, wherein the connectors are normally-closed. The BMS resides within a housing of the battery between the battery cells and one of the battery terminals. The BMS measures the voltage of each battery cell and determines a voltage difference between a lowest-voltage cell and a highest-voltage cell. The BMS may also balance the charging and discharging of the battery cells to maintain the voltage difference within a predetermined maximum value. The battery also includes a sense module designed to detect voltage changes within the battery.

### STATEMENT OF RELATED APPLICATIONS

The present application is filed as a Continuation-in-Part of U.S. Ser. No. 19/048,189 filed Feb. 7, 2025. That application is titled “Battery With Internal Monitor and Display.”

That application claimed priority to International Patent Application PCT/US2023/075533 filed Sep. 29, 2023.

The International Patent application claimed the benefit of U.S. Provisional Patent Application No. 63/411,261.

The present application also claims the benefit of U.S. Ser. No. 63/756,199 filed Feb. 9, 2025. That application was titled “Battery Management System For A Marine Battery.”

Each of these prior applications is incorporated herein in its entirety by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### TECHNICAL FIELD OF THE INVENTION

The present disclosure relates to the field of energy storage devices. More specifically, the present subject matter relates to marine batteries. Further still, the present invention relates to a marine battery having a power management system and a plurality of battery cells, wherein the battery cells may be drained down to 0V for transportation and storage.

### DISCUSSION OF THE BACKGROUND

It is common to use a lithium-ion battery for marine applications. Lithium-ion batteries have certain advantages over lead-acid batteries. These include high energy density, fast charging, low maintenance, and a relatively long lifespan. For example, Lithium-ion batteries can last up to 10 times longer than comparable lead-acid batteries. In addition, Lithium-ion batteries can withstand thousands of charge-discharge cycles, while lead-acid batteries typically last only 500-1,000 cycles. Lithium batteries can be re-charged in as little as four hours, and can be recharged multiple times a day.

However, there are dangers associated with transporting Li-ion batteries. Li-ion batteries can overheat, catch fire, or even explode. For this reason, commercial airlines generally do not allow Li-ion batteries to be stored inside passenger luggage.

To reduce the risk of overheating, battery manufacturers try to drain the battery of charge prior to shipment or storage. However, Li-ion batteries do not tolerate being discharged below about 30% SoC.

Therefore, it is desirable to provide a marine battery that functions with the advantages of a Lithium-ion battery, but can be discharged down to 0V. It is an object herein to provide a battery having a plurality of battery cells, wherein the battery cells may be drained down to 0V. An example of such a battery is a Sodium-ion cell battery, which functions in a manner similar to a capacitor. It is also desirable to provide a battery management system (BMS) that employs a normally-closed contactor.

### SUMMARY OF THE INVENTION

A battery is provided. In one aspect, the battery first comprises a housing. The housing is a sealed, watertight housing for marine applications.

The battery has a positive terminal and a negative terminal. Each of these terminals is supported by and may extend out from the housing.

The battery also includes a plurality of battery cells, with the battery cells being disposed within the housing. The battery cells are in electrical communication with the positive and negative terminals. Beneficially, the plurality of battery cells are configured to be drained to 0V for shipment or storage. Preferably, the battery cells comprise sodium-ion cells, lithium-sulfur cells, or magnesium-ion cells.

The battery also comprises a battery management system. The battery management system resides within the housing, and is in electrical communication with the plurality of battery cells. The battery management system comprises one or more normally-closed connectors placed between the battery cells and the negative terminal.

Preferably, the battery management system further comprises a micro-controller. The micro-controller is configured to measure the voltage of each battery cell and determine a voltage difference (ΔV) between a lowest-voltage cell and a highest-voltage cell. The battery management system is configured to balance charging and discharging of the plurality of battery cells to maintain the (ΔV) at less than a predetermined maximum value.

Optionally, the battery further comprises a communications module. The communications module is disposed within the housing and is in electrical communication with the sense module. The communications module is configured to receive the battery status information and transmit the network communication data containing the battery status information.

Optionally, the battery further comprises a network interface, wherein the network interface is also disposed within the housing. The network interface is in electrical communication with the communications module, and is configured to connect directly to a NMEA 2000 network connector and communicate the battery status information via the NMEA 2000 network connector.

The battery may also have a data interface. The data interface is configured to output the battery status information wirelessly or via a wired NMEA 2000 network connector.

Optionally, the battery includes a sense module. The sense module is also disposed within the housing. The sense module is in electrical communication with the plurality of battery cells. Preferably, the sense module resides between the battery cells and the positive terminal.

Preferably, the sense module comprises:
a memory chip;
a coulomb counter configured to measure electric charge (in coulombs); and
a current shunt in electrical communication with the coulomb counter for monitoring energy flow into or out of the plurality of battery cells.

It is understood that because the BMS includes a normally closed contactor, the sense module is not required.

### BRIEF DESCRIPTION OF THE DRAWINGS

So that the manner in which the present inventions can be better understood, certain illustrations, charts, and/or flow charts are appended hereto. It is to be noted, however, that the drawings illustrate only selected embodiments of the inventions and are therefore not to be considered limiting of scope, for the present subject matter may admit to other equally effective embodiments and applications.

FIG. 1 presents a schematic view of a battery according to an embodiment of the invention. The schematic view reveals components inside the battery, including a battery management system.

FIG. 2 depicts a top perspective view of the battery of FIG. 1, in one aspect.

FIG. 3 depicts a top plan view of the battery according to an embodiment of the present disclosure.

FIGS. 4A and 4B depict views of the layout of internal components of the battery of FIG. 1, according to an embodiment of the invention.

FIG. 5 depicts a button assembly and status LED's according to an embodiment of the invention.

FIG. 6 depicts a state-of-charge (SoC) indicator LED according to an embodiment of the invention.

### DEFINITIONS

Reference herein to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment.

### DETAILED DESCRIPTION OF CERTAIN EMBODIMENTS

The following description of the embodiments refers to the accompanying drawings. The same reference numbers in different drawings identify the same or similar elements. The following detailed description does not limit the presently disclosed subject matter; instead, the scope of the embodiments herein is defined by the appended claims.

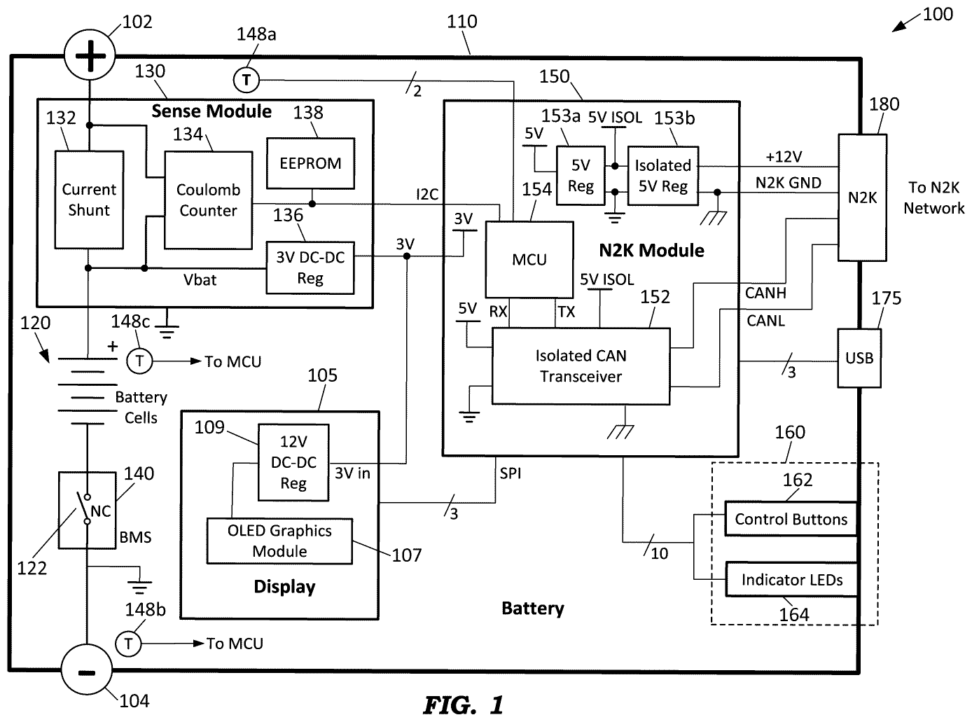

FIG. 1 presents a schematic view of a battery 100 according to an embodiment of the invention. The schematic view reveals components inside the battery 100. The battery 100 is designed for inductive loads, such as trolling motors. Of course, the battery is also capable of providing engine starts, such as for an internal combustion engine on a boat. The battery 100 features high-power cells 120 and a high-current battery management system (BMS) 140. The battery 100 is designed for repeated pulse loading and alternator charging. The battery 100 is also capable of dampening voltage transients.

The battery 100 first comprises a shell, or housing 110. The housing 110 securely holds internal components of the battery 100 such as the BMS 140. Of importance for marine applications, the housing 110 provides a sealed, watertight housing for a plurality of battery cells 120.

In the present disclosure, the battery cells 120 may represent a sodium-ion battery. Alternatively, the battery cell 120 may be a lithium-sulfur battery or a magnesium-ion battery. Such battery cells are akin to a capacitor in that they can be safely discharged to zero volts. One benefit is that such batteries may be safely shipped or stored at zero volts, and then recharged.

The housing 110 supports a positive terminal 102 and a negative terminal 104. The terminals 102, 104 are at least partially external to the housing 110.

An optional OLED display 105 is provided on the housing 110. The OLED display 105 may include a graphics module 107 and a 12V DC-DC regulator 109. A USB port 175 may also be provided on the housing 110. The USB port 175 is useful for firmware upgrades.

As noted, the battery 100 also includes a battery management system (BMS) 140. In the case where multiple cells are employed within the battery 120, the BMS 140 protects and balances the battery cells. Cell balancing involves measuring the voltage in each cell and using the voltage data to monitor the voltage Delta (ΔV), which is the difference in measured voltage between the lowest-voltage cell and the highest-voltage cell. The cell balancing is intelligent, and continues to balance the cells 120 to operate within a factory pre-set maximum (ΔV). In this way, the BMS 140 also serves as a safety system to ensure the cells 120 are maintained within their safe window of operation.

In one aspect, the BMS 140 provides monitoring and protection for cell level over-voltage, pack level over-current, short circuit, over-temperate, and under-temperature. If any out-of-range condition develops, the BMS 140 interrupts the flow of current as needed.

If any of the cells 120 reaches an out-of-range voltage, the BMS 140 may be programmed to shut down the entire battery 100. If the shutdown was due to high voltage in one or more cells 120 during charging, the BMS 140 may automatically reset when the out-of-range cell's voltage comes back down to within its factory pre-set voltage, typically within five minutes after the charge voltage is removed. If the shutdown was due to low voltage in one or more of the cells 120, the BMS 140 may automatically reset when a charger is connected.

It is observed that the conventional lithium-ion battery management systems rely on relays or contactors that are normally-open. In some instances, a normally-open MOSFET is used with a driver that closes the contacts. If the system voltage drops, the contactor opens. For this reason there is no way to keep the contactor conducting energy while the battery pack goes to zero volts.

As noted, Li-ion batteries should not be discharged below 30% SoC, even for transportation and storage. As a result, Li-ion battery cells must be air-freight transported at considerable cost. Therefore, it is proposed herein to employ sodium-ion cells which can be fully discharged to zero volts, akin to a capacitor. In this state, the potential for thermal runaway due to short-circuiting is eliminated.

It is further desirable to have a BMS that uses relays that are normally closed (NC) when no energy is present. This is advantageous for transportation and storage. Thus, the BMS 140 disclosed herein employs normally-closed contactors 122 with the sodium-ion battery cells 120. Normally-closed contactors are known to be used to ensure that the contactor closes a circuit in the event of a voltage drop, such as a power failure. In this case, the battery cells 120 are intentionally drained. The contactors 122 may be magnetically latching or simply normally-closed. Error conditions such as over-charge current or over-cell voltage would open the contactors 122.

The battery 100 of FIG. 1 may optionally include a sense module 130. The sense module 130 includes a current shunt 132 for monitoring energy flow into or out of the battery cell 120. The sense module 130 may also include a coulomb counter 134 for estimating the state of charge (SoC) of the cell 120, and a 3V DC-DC voltage regulator 136. In addition, the sense module 130 may have an EEPROM 138.

The sense module 130 resides electrically between the battery 120 and one of the terminals 102, 104. In the arrangement of FIG. 1, the sense module 130 resides between the battery 120 and the positive terminal 102.

The battery 100 also optionally includes an NMEA 2000 Module 150. This may be referred to as a communications module, or as an N2K Module 150. The NMEA 2000 Module 150 is a plug-and-play communications standard used for connecting marine sensors and display units within marine vehicles. Devices that use the NMEA 2000 protocol can communicate with any other NMEA 2000 compatible sensor, display unit, or other device on a communications network.

Beneficially, NMEA 2000 Module 150 is electrically compatible with the Controller Arca Network (CAN) communication protocol used on road vehicles. NMEA2000 communications systems can be used to create a network of electronic marine instruments and devices via one central backbone cable that provides power to and relays data between all of the devices on the network. This allows one display unit on the network to display information from may different types of marine devices.

The NMEA 2000 Module 150 includes 5V voltage regulators 153a, 153b. The Module 150 also has an isolated CAN transceiver 152, and a controller 154. The controller 154 may be an ARM Cortex Micro-Control Unit (MCU).

As depicted in FIG. 1, the NMEA 2000 Module 150 communicates with an NMEA 2000 micro-port interface 180. Together, the NMEA 2000 Module 150 and the NMEA 2000 micro-port interface 180 provide a direct connection to an NMEA 2000 network within the boat or other vehicle in which the battery 120 is installed.

The NMEA 2000 module 150 is NMEA 2000 certified, directly addressable on a NMEA 2000 network, and is compatible with all NMEA 2000 multi-function displays. In a preferred embodiment, the NMEA 2000 module 150 uses signals from the coulomb counter 134 with Peukert exponent and temperature measurements in capacity/time calculations. The temperature measurements are based on signals from three thermistors 148a, 148b, 148c. These are placed near the positive terminal 12a, near the negative terminal 12b and near the battery cells 120, respectively.

The BMS 140 reports all required alerts in Parameter Group Number (PGN) format as well as standard battery related PGN alerts (127506, 127508, 127513, 126983). Through the NMEA 2000 interface 180, the NMEA 200 module 150 puts individual battery voltage, current, time remaining, state of charge, amp-hours consumed, and temperatures of the cells 120 and terminals 102, 104 on the network in the prescribed PGN formats. The NMEA 2000 module 150 records warnings and alert events with a real time/date stamp, and records cumulative lifetime amp-hours, all of which is viewable on the optional OLED display 105. The NMEA 2000 module 150 operates with firmware that can be field updated using the USB port 175.

The NMEA 2000 module 150 provides a precise SoC indication in any given condition, while idling or charging or discharging. During normal cycling of the battery 100, the NMEA 2000 module 150 monitors some significant points in the SoC. For example, when the battery voltage rises to a predetermined level and remains at that level while the amperage falls to a predetermined level, the NMEA 2000 module 150 will “Sync”, meaning that it will assume the battery 100 is at 100% SoC. At this point, the NMEA 2000 module 150 updates the “Lifetime Ah”, updates the SoC to 100%, and updates “Charge Used” to 0.0 Ah.

In operation, the BMS 140 may include over-current protection and short circuit protection. Over-current, either during charging or discharging, trips the over-current protection. The system automatically resets after all of the cables and wires are disconnected from the ground terminal on the battery 120 for at least 10 seconds, and then reconnected.

With regard to thermal protection, in the event the battery's internal temperature exceeds preset high or low limits, the BMS 140 shuts down the battery 120. The system 140 automatically resets when the temperature of the battery 120 returns to within an acceptable range.

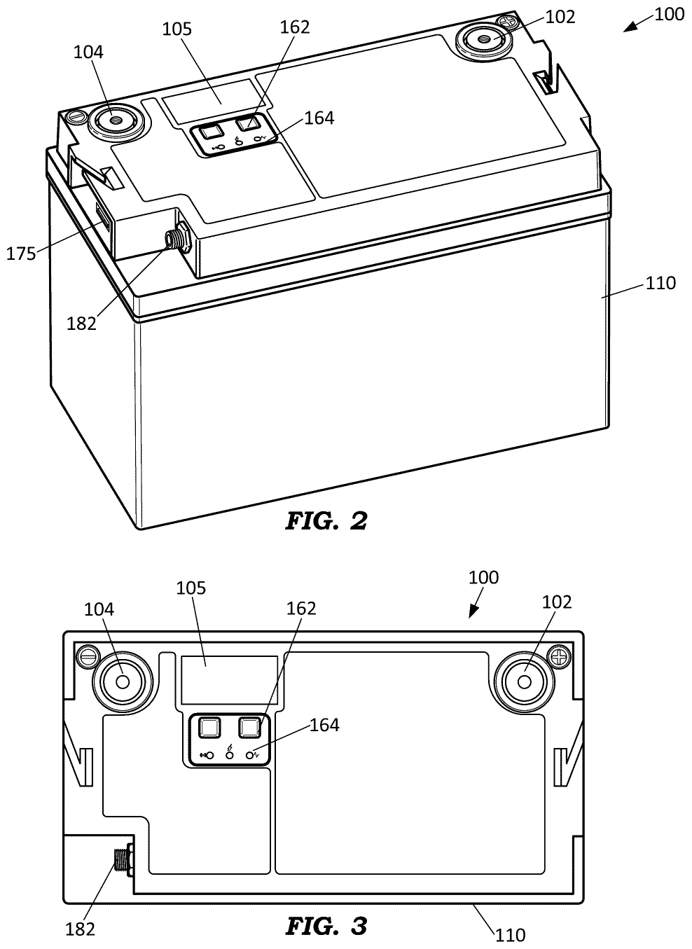

FIG. 2 depicts a top perspective view of the battery 100 of FIG. 1, in one aspect. A connector 182 is shown, providing a means of communication with the network interface 180.

FIG. 3 depicts a top plan view of the battery 100 of FIG. 2.

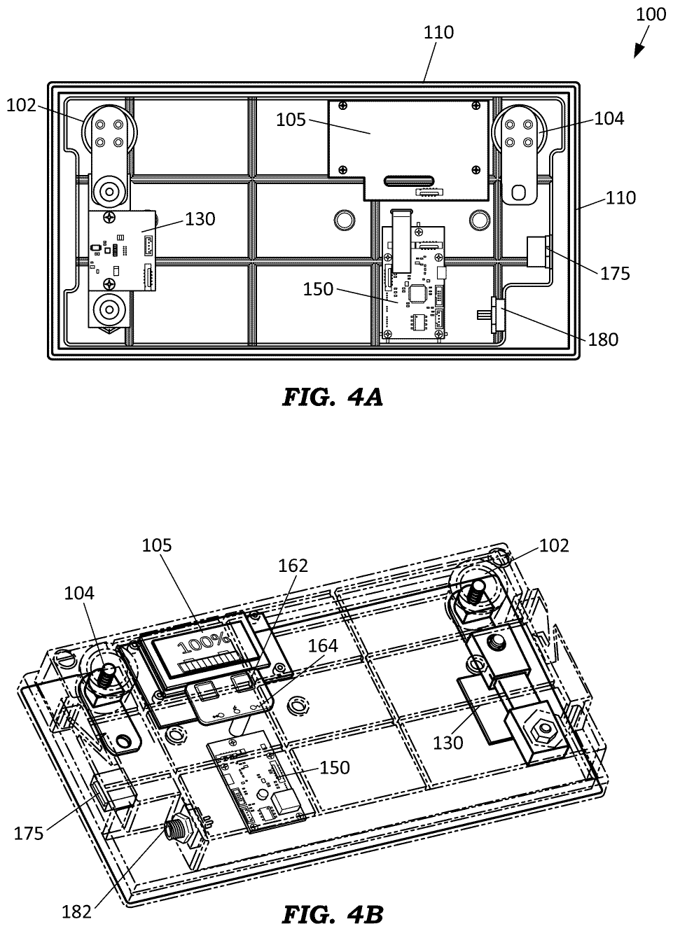

FIGS. 4A and 4B depict views of the layout of internal components of the battery 100 of FIG. 1, according to an embodiment of the invention.

The battery 100 of FIG. 1 also includes a membrane control assembly 160. The membrane control assembly 160 includes control buttons 162 and status indicator LED's 164.

When the battery 100 is discharging, the NMEA 2000 module 150 shows the percent SoC, charge used, and time remaining. Once the battery 100 reaches 10% SoC, a flashing alert is activated. When the battery 100 drains down to 0% SoC, alerts are generated, an alarm log entry is made, the red alarm LED 164 flashes, and the word “**LO**” appears above the battery icon on the display screen 105.

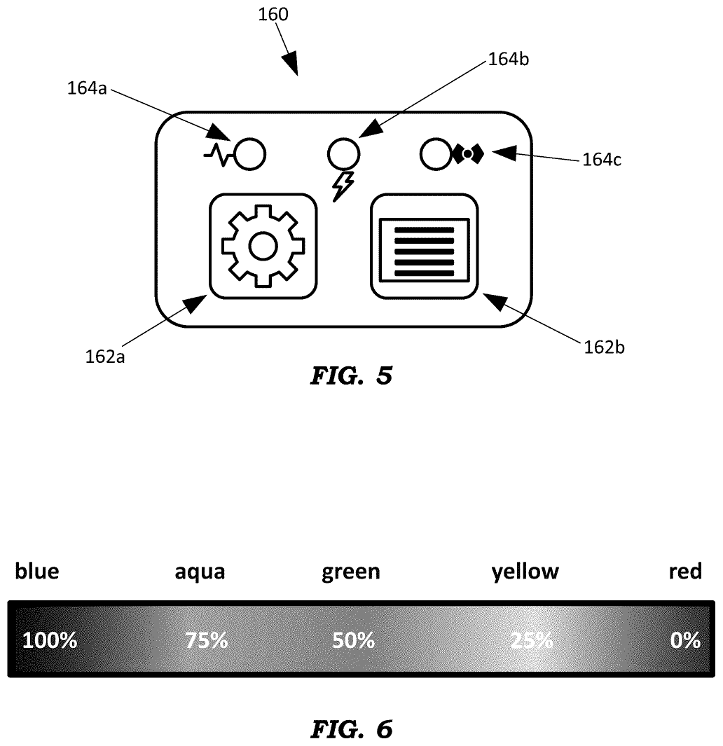

In a preferred embodiment, and as depicted in FIG. 5, the NMEA 2000 module 150 is controlled using the membrane control assembly 160. The membrane control assembly 160 includes two control buttons 162 and three status indicator LED's 164. The buttons may include a setup button 162a and a display button 162b. At the same time, the LEDs 164 may include an Activity LED 164a, an SoC LED 164b, and an Alarm/Warning LED 164c.

The Activity LED 164a has the following behavior based on certain events:
Rapid flash when any NMEA 2000 PGN is sent or received;
Flashes on during NMEA 2000 initialization and address claiming (i.e., when the NMEA 2000 cable is attached);
Solid on while synching, and five short flashes when complete;
Solid on after Restart/Reset initiated, and turns off when restart is complete;
During Zero Calibration, flashes for every data sample taken, and one long flash if the calibration is successful, and rapidly flashes for five seconds if a calibration failure occurs.

Repeatedly pressing the display button 162b toggles through various screens on the display 105, such as in the following order:
Splash screen (logo and www.lithiumpros.com) displays for two seconds on MCU reset, but not in rotation;
Logo, website, battery model and type screen;
Battery information screen including Lifetime Ah cycled;
NMEA 2000 information, if connected;
Alarm log (only displayed if an alarm has occurred);
Warning log (only displayed if a warning has occurred);
SoC (including a factory-determined reserve, which means there is still an undetermined reserve in the battery before BMS shutdown when 0% id displayed);
Time remaining in hours (displays “>24 hr” if time remaining is over 24 hours at this amperage load and “Charging” if the amperage is positive);
Current (+/−) or amperage (positive value if the battery is charging and a negative value if it is discharging);
Charge used (Ah) (actual amp-hours of energy removed from the battery since the last charge, will indicate 0.0 when the battery is full);
Volts (V);
Internal temperature (F/C) or cell temperature (selectable in either Fahrenheit or Celsius); and
Terminal temperature (F/C), which is max of either the positive or negative terminal (selectable in either Fahrenheit or Celsius).

The setup button 162a is used to select functions to be executed by pressing the button 162a various lengths of time. All timed buttons operate when the setup button 162a is released. If the SoC is >98%, the SoC may be manually set to 100% (i.e., “Synced”) by pressing and holding the setup button 162a for more than 5 seconds and less than 10 seconds (e.g., 7 seconds). When the setup button 162a is released, the Activity LED 164a illuminates solid while the sync operation is in process.

Upon successful sync, the Activity LED 164a flashes five times. The OLED display 105 can be rotated 180 degrees for easier viewing by pressing and holding the setup button 162a for more than 10 seconds and less than 15 seconds (e.g., 12 seconds). When the setup button 162a is released, the message “Display flipped” flashes and then returns to the normal display.

The OLED display 105 can display temperature in either Fahrenheit or Celsius, which can be toggled pressing and holding the setup button 162a for more than 15 seconds and less than 20 seconds (e.g., 17 seconds). When the setup button 22a is released, the setting returns to the normal display mode. The BMS 140 can be restarted by pressing and holding the setup button 162a for more than 30 seconds and then releasing. When the setup button 162a is released, the Activity LED 164a goes solid and then off, and the restart commences.

FIG. 6 depicts a state-of-charge (SoC) indicator LED 164b according to an embodiment of the invention. As shown in FIG. 6, the SoC LED 164b changes color according to the SoC. In a preferred embodiment, this LED 164b is only on for a short period of time when the display button 162b is pushed. The LED 164b will come on solid if the SoC is less than 25%. The Alarm/Warming LED 164c slowly blinks (such as one second on, one second off) if any alarm is triggered, and rapidly blinks if a warming or alarm is active and stops blinking if no warning or alarms are active.

It should be understood that this description is not intended to limit the invention; on the contrary, the exemplary embodiments are intended to cover alternatives, modifications, and equivalents, which are included within the spirit and scope of the invention as defined by the appended claims. For example, item 100 of FIG. 1 may represent an energy storage device, with cells 140 representing super-capacitor cells.

Further, in the detailed description, specific details are set forth in order to provide a comprehensive understanding of the claimed invention. However, one skilled in the art would understand that various embodiments may be practiced without such specific details.

Further, variations of the battery 100 may fall within the spirit of the claims, below. It will be appreciated that the inventions are susceptible to other modifications, variations, and changes without departing from the spirit thereof.

I claim:

1. A battery for marine applications, the battery comprising:
a watertight housing;
a positive terminal and a negative terminal supported by the housing;
a plurality of battery cells disposed within the housing in electrical communication with the positive and negative terminals, wherein the plurality of battery cells are configured to be drained to 0V for shipment or storage; and
a battery management system residing within the housing and in electrical communication with the plurality of battery cells, and comprising one or more normally-closed connectors between the battery cells and the negative terminal.

2. The battery of claim 1, wherein the battery cells comprise sodium-ion cells, lithium-sulfur cells, or magnesium-ion cells.

3. The battery of claim 2, wherein:
the battery cells comprise sodium-ion cells; and
the contactors comprise a magnetically latching relay.

4. The battery of claim 2, wherein the battery management system further comprises:
a micro-controller configured to measure the voltage of each battery cell and determine a voltage difference (ΔV) between a lowest-voltage cell and a highest-voltage cell, and to balance charging and discharging of the plurality of battery cells to maintain the (ΔV) at less than a predetermined maximum value.

5. The battery of claim 2, further comprising:
a sense module disposed within the housing and in electrical communication with the plurality of battery cells, with the sense module residing between the battery cells and the positive terminal.

6. A battery for marine applications, the battery comprising:
a watertight housing;
a positive terminal and a negative terminal supported by the housing;
a plurality of battery cells disposed within the housing in electrical communication with the positive and negative terminals, wherein the plurality of battery cells are configured to be drained to 0V for shipment or storage;
a sense module disposed within the housing and in electrical communication with the plurality of battery cells, with the sense module residing between the battery cells and the positive terminal; and
a battery management system residing within the housing and in electrical communication with the plurality of battery cells, and comprising one or more normally-closed connectors between the battery cells and the negative terminal.

7. The battery of claim 6, wherein the battery cells comprise sodium-ion cells, lithium-sulfur cells, or magnesium-ion cells.

8. The battery of claim 7, further comprising:
a communications module disposed within the housing and in electrical communication with the sense module, the communications module configured to receive the battery status information and transmit the network communication data containing the battery status information; and
a network interface disposed within the housing and in electrical communication with the communications module, the network interface configured to connect directly to a NMEA 2000 network connector and communicate the battery status information via the NMEA 2000 network connector directly to an NMEA 2000 network.

9. The battery of claim 7, wherein the battery management system further comprises:
a micro-controller configured to measure the voltage of each battery cell and determine a voltage difference (ΔV) between a lowest-voltage cell and a highest-voltage cell, and to balance charging and discharging of the plurality of battery cells to maintain the (ΔV) at less than a predetermined maximum value.

10. The battery of claim 9, wherein the sense module comprises:
a memory chip;
a coulomb counter configured to measure electric charge in coulombs; and
a current shunt in electrical communication with the coulomb counter for monitoring energy flow into or out of the plurality of battery cells.

11. The battery of claim 7, further comprising:
an OLED display configured to display the battery status information.

12. The battery of claim 11, further comprising:
a data interface configured to output the battery status information wirelessly or via a wired NMEA 2000 network connector.

13. An energy storage device for marine applications, the energy storage device comprising:
a watertight housing;
a positive terminal and a negative terminal supported by the housing;
a plurality of super-capacitor cells disposed within the housing in electrical communication with the positive and negative terminals, wherein the plurality of super-capacitor cells are configured to be drained to 0V for shipment or storage; and
a power management system residing within the housing and in electrical communication with the plurality of super-capacitor cells, and comprising one or more normally-closed connectors between the super-capacitor cells and either the positive terminal or the negative terminal.

14. The energy storage device of claim 13, wherein the power management system further comprises:
a micro-controller configured to measure the voltage of each super-capacitor cell and determine a voltage difference (ΔV) between a lowest-voltage cell and a highest-voltage cell, and to balance charging and discharging of the plurality of super-capacitor cells to maintain the (ΔV) at less than a predetermined maximum value.
